(19) United States
(12) Patent Application Publication
(10) Pub. No.: US 2008/0109507 A1
(43) Pub. Date: May 8, 2008

(54) SYSTEM AND METHOD FOR PERFORMING AN OPTIMIZED DISCRETE WALSH TRANSFORM

(75) Inventors: Roger Eric Garcia, McKinney, TX (US); Robert Ryan Morton, Heath, TX (US); Dennis J. Stopczynski, Rockwall, TX (US)

Correspondence Address: HOVEY WILLIAMS LLP, 10801 Mastin Blvd., Suite 1000, Overland Park, KS, 66210, US

(73) Assignee: L3 COMMUNICATIONS INTEGRATED SYSTEMS, L.P., GREENVILLE, TX (US)

(21) Appl. No.: 11/551,998

(22) Filed: Oct. 23, 2006

(51) Int. Cl. G06F 7/50

(52) U.S. Cl. 708/670

(57) ABSTRACT

A circuit (26) performs a discrete Walsh transform using a reduced set of arithmetic operators. The circuit (26) comprises a first memory component (32), an adder (36), a subtractor (38), a second memory component (40), and a controller (52). In each of a plurality of stages, the controller (52) enables the first memory component (32) to communicate each of a plurality of pairs of values stored therein to the adder (36) and to the subtractor (38). The controller (52) enables the second memory component (40) to store each of a plurality of results from the adder (36) and the subtractor (38) and to communicate the stored results to the first memory component (32) for use in a subsequent stage. In the subsequent stage, the controller (52) enables the first memory component (32) to communicate to the adder (36) and to the subtractor (38) a plurality of new pairs of data values consisting first of the add results from the previous stage in the order they were generated and then the subtract results in the order they were generated.

### STATEMENT REGARDING FEDERALLY SPONSORED RESEARCH

The present invention was developed with support from the U.S. government under a contract with the United States Department of Defense, Contract No. 3066290. Accordingly, the U.S. government has certain rights in the present invention.

### BACKGROUND OF THE INVENTION

1. Field of the Invention

Embodiments of the present invention relate to a system and method for performing an optimized orthogonal transform. More particularly, embodiments of the invention involve a system and method for performing a discrete Walsh transform that is scalable and employs a reduced set of arithmetic operators, wherein the number of arithmetic operators is the same for different Walsh code lengths.

2. Description of Prior Art

The Walsh transform is used in communication systems to implement signal processing operations. The Walsh transform involves receiving as an input a set of values and multiplying the set of values by a Walsh-Hadamard matrix of commensurate size. The number of input values is equal to a power of two. The Walsh-Hadamard matrix is a square, orthogonal matrix with dimensions that are a power of two. All values of the matrix are either +1 or −1.

It is often desirable to implement the Walsh transform with hardware instead of software. Existing methods of performing the Walsh transform using dedicated hardware components require the use of multipliers, cascaded arithmetic circuit stages, or both. U.S. Pat. No. 5,357,454, for example, discloses a Walsh transform processor that requires several circuit stages, wherein each stage includes eight arithmetic circuit elements. Unfortunately, these existing methods require a large number of circuit elements to perform the transform, which is undesirable in applications where minimizing circuit size is key.

Accordingly, there is a need for an improved system and method for performing a Walsh transform that does not suffer from the problems and limitations of the prior art.

### SUMMARY OF THE INVENTION

Embodiments of the present invention provide an improved system and method for performing an optimized orthogonal transform that does not suffer from the problems and limitations of the prior art. Particularly, embodiments of the present invention provide a system and method for performing a discrete Walsh transform that is scalable and employs a reduced set of arithmetic operators, wherein the number of arithmetic operators is the same for different Walsh code lengths.

A first embodiment of the invention is a circuit for processing a set of values. The circuit comprises access to a memory component, an adder, a subtractor, and a controller that enables the memory component, adder, and subtractor to process a set of values in a plurality of stages. In each stage the controller enables the memory to communicate each of a plurality of pairs of values stored in the memory to the adder and to the subtractor to generate add results and subtract results, and enables the memory to store the add results and the subtract results for use in a subsequent stage. In the subsequent stage, the controller enables the memory to communicate to the adder and to the subtractor a plurality of new pairs of values consisting first of the add results in the order they were generated and then the subtract results in the order they were generated.

A second embodiment of the invention is a method of performing a Walsh transform on a set of values. The method comprises communicating each of a plurality of pairs of values stored in a memory circuit to an adder input and to a subtractor input and storing in the memory circuit an output value of the adder and an output value of the subtractor corresponding to each pair of values.

The method further comprises communicating to the adder input and to the subtractor input the adder output values and the subtractor output values stored in the memory circuit. The adder output values and the subtractor output values are communicated to the adder input and to the subtractor input in pairs consisting first of the adder output values in the order they were generated and then the subtractor output values in the order they were generated.

A third embodiment of the invention is a circuit for performing a discrete Walsh transform on a set of signal values. The circuit comprises a first memory component with an input and an output, a second memory component with an input and an output, and a single, two-input adder with first and second inputs connected to the output of the first memory component and an output connected to the input of the second memory component. The first adder input receives a first value from the first memory component and the second adder input receives a second value from the first memory component.

The circuit further comprises input circuit elements for receiving a stage value, and a single, two-input subtractor with first and second inputs connected to the output of the first memory component and an output connected to the input of the second memory component. The first subtractor input receives a first value from the first memory component and the second subtractor input receives a second value from the first memory component.

Arithmetic control circuit elements enable the first memory component to communicate pairs of data values to the adder and the subtractor, and enables the second memory component to store an output of the adder and an output of the subtractor corresponding to each pair of input values. The add results are stored sequentially first, in the order they were generated, and the subtract results are stored sequentially after the add results, in the order they were generated.

Stage control circuit elements enable the second memory component to communicate the outputs of the adder and the subtractor to the first memory component when the number of pairs communicated to the adder and the substractor equals one-half of the stage value. The outputs of the adder are stored in the first memory component in the same order they were stored in the second memory component.

These and other important aspects of the present invention are described more fully in the detailed description below.

### BRIEF DESCRIPTION OF THE DRAWINGS

Preferred embodiments of the present invention are described in detail below with reference to the attached drawing figures, wherein:

FIG. 1 illustrates mathematical operations involved in performing a Walsh transform on two data values D₁ and D₂;

FIG. 2 illustrates mathematical operations involved in performing a Walsh transform on four data values D₁-D₄;

FIG. 3 illustrates mathematical operations involved in performing a Walsh transform on eight data values D₁-D₈;

FIG. 4 is an exemplary circuit operable to implement the Walsh transform of FIGS. 1-3 with minimal arithmetic components;

FIG. 5 is a flowchart of steps performed by the circuit of FIG. 4;

FIG. 6 illustrates a first stage of arithmetic operations performed by the circuit of FIG. 4 on a set of eight data values, wherein the operations are performed on eight original data values D₁-D₈;

FIG. 7 illustrates a second stage of arithmetic operations performed by the circuit of FIG. 4, wherein the second stage operations are performed on values generated by the arithmetic operations of the first stage; and

FIG. 8 illustrates a third stage of arithmetic operations performed by the circuit of FIG. 4, wherein the third stage operations are performed on values generated by the arithmetic operations of the second stage and generate values equal to the results of the Walsh transform on the original data values.

### DETAILED DESCRIPTION

The Walsh transform is used to implement certain signal processing operations and involves receiving as an input a set of values and multiplying the set of values by a Walsh-Hadamard matrix of commensurate size. The number of input values is equal to a power of two, and the Walsh-Hadamard matrix is a square, orthogonal matrix with dimensions that are a power of two. All values of the matrix are either +1 or −1.

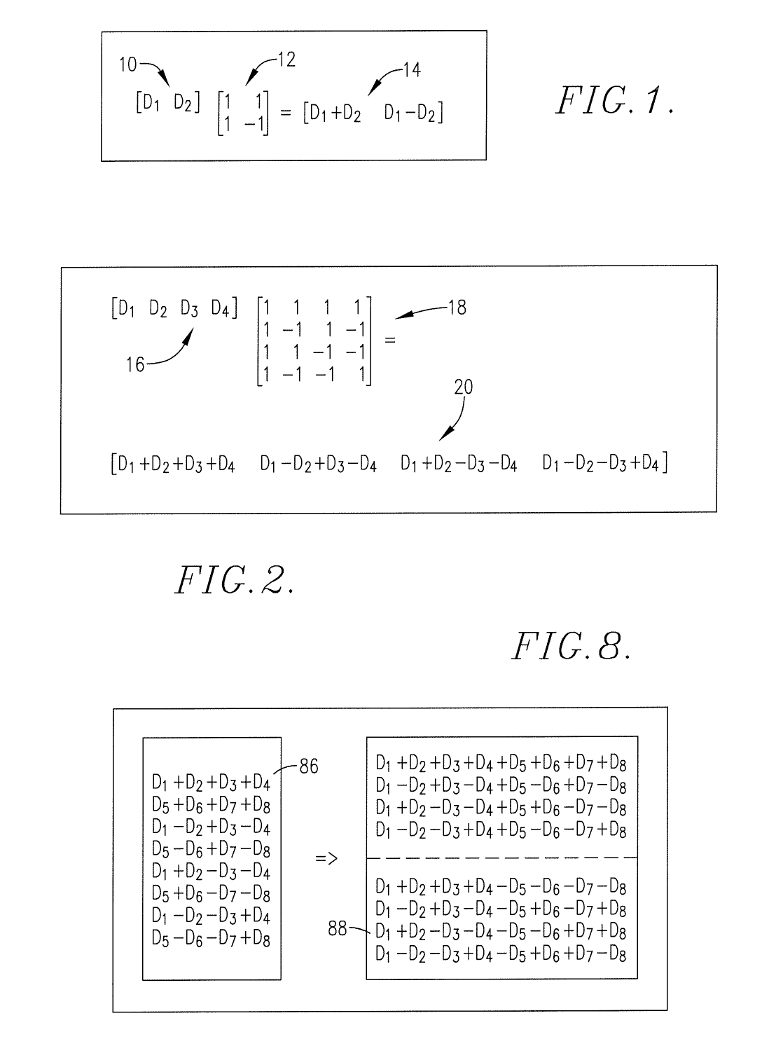

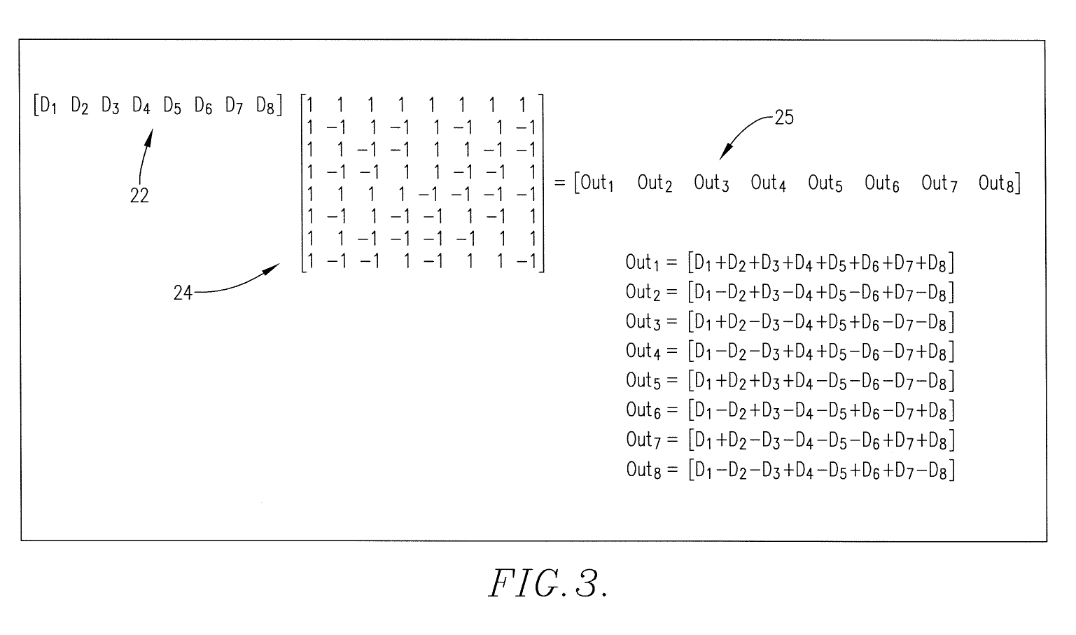

The Walsh transform is illustrated in FIGS. 1-3, wherein FIG. 1 illustrates mathematical operations involved in performing a Walsh transform with a Walsh code length of two (i.e., there are two input values, D₁ and D₂), FIG. 2 illustrates mathematical operations involved in performing a Walsh transform with a Walsh code length of four, and FIG. 3 illustrates mathematical operations involved in performing a Walsh transform with a Walsh code length of eight. The transform of FIG. 1 involves matrix multiplication of a 2×1 input matrix 10 by a 2×2 Walsh-Hadamard matrix 12 to yield a 2×1 output matrix 14. The input values D₁ and D₂ may be, for example, sampled values of a communications signal. The transform of FIG. 2 involves matrix multiplication of a 4×1 input matrix 16 by a 4×4 Walsh-Hadamard matrix 18 to yield a 4×1 output matrix 20. The transform of FIG. 3 involves matrix multiplication of an 8×1 input matrix 22 by an 8×8 Walsh-Hadamard matrix 24 to yield an 8×1 output matrix 25. Note that in FIG. 3, the output matrix 25 values are defined below the matrix 25.

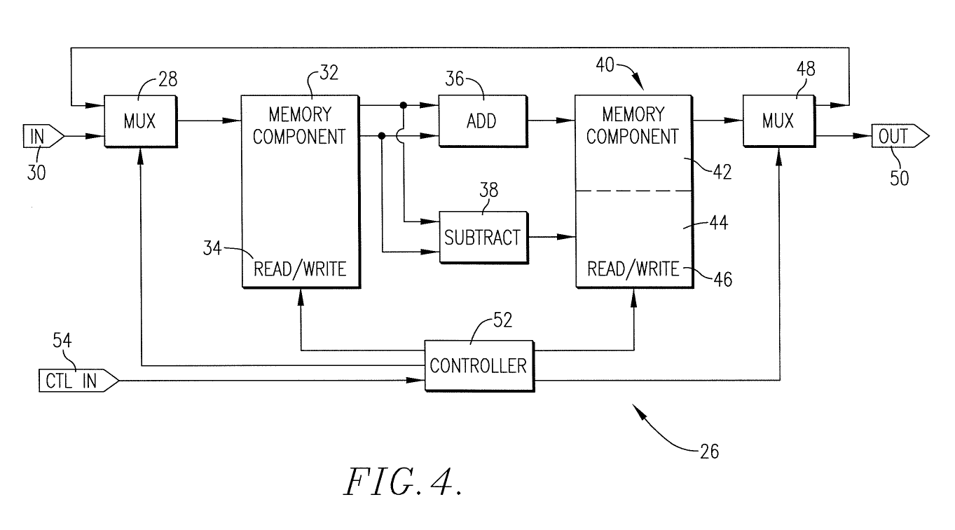

An exemplary circuit for implementing the Walsh transform is illustrated in FIG. 4 and designated generally by the reference numeral 26. The circuit 26 is preferably implemented in a programmable logic device or an application specific integrated circuit, but may be implement in whole or in part using discrete components. The circuit 26 generally comprises a first multiplexer 28; a data input 30; a first memory component 32 with a read/write control input 34; an adder 36; a subtractor 38; a second memory component 40 divided into an add portion 42 and a subtract portion 44 and including a read/write control input 46; a second multiplexer 48; a data output 50; a controller 52; and a control input 54.

The first multiplexer 28 receives data from the data input 30 as well as from the second multiplexer 48, and communicates data from one of those two sources to the first memory component 32 according to a control signal received from a controller 52. The circuit 26 may be developed to accommodate data values of virtually any size and type, but standard data values include 16, 32, and 64-bit integers. For illustrative purposes only, the data input 30 will be described as communicating 16-bit integer values to the multiplexer 28.

The first memory component 32 receives and stores data communicated from the first multiplexer 28, and communicates the data to the adder 36 and the subtractor 38 according to a control signal communicated from the controller 52 to the read/write input 34 of the first memory component 32. The first memory component 32 stores the data values in a conventional manner and may be, for example, a register array functionally arranged in a first-in-first-out (“FIFO”) configuration. Those skilled in the art will appreciate that the first memory component 32 may be volatile or non-volatile memory and may be logically arranged according to alternative configurations, including last-in-first-out or addressed configurations.

The adder 36 and the substractor 38 include conventional add and subtract circuits, respectively. The adder 36 and the subtractor 38 each has two inputs and generates a single output representing the result of its respective arithmetic operation. If the data values received from the data input 30 are 16-bit integers, for example, the adder 36 may have two 16-bit inputs and a single 16-bit output, wherein the carry bit may be discarded without adversely affecting the operation of the circuit 26. Similarly, the subtractor 38 may have two 16-bit inputs and a single 16-bit output and implement a conventional subtraction operation, such as converting one of the two input values to twos complement form and adding the converted value to the other of the two input values.

The outputs of both the adder 36 and the subtractor 38 are communicated to the second memory component 40. The second memory component 40 includes two inputs, a first input corresponding to an add portion 42 of the component 40 and a second input corresponding to a subtract portion 44 of the component 40. Each of the add portion 42 and the subtract portion 44 functions as a separate FIFO, although both are controlled by the read/write input 46.

The first memory component 32 and the second memory component 40 may be part of the circuit 26, as illustrated in FIG. 4, or may alternatively be external to the circuit 26. Furthermore, the circuit 26 may include access to the memory components 32,40 rather than the memory components themselves.

The second multiplexer 48 receives data from the second memory component 40 and communicates the data to either the first multiplexer 28 or to the data output 50 according to a control signal received from a controller 52.

The controller 52 receives control data from the control input 54 and directs operation of the first multiplexer 28, the first memory component 32, the second memory component 40, and the second multiplexer 48 to enable the circuit 26 to perform a discrete Walsh transform on a set of values received via the data input 30 in a plurality of stages.

More particularly, in each stage the controller 52 enables the first memory component 32 to communicate each of a plurality of pairs of values stored therein to the adder 36 and to the subtractor 38. The controller 52 enables the second memory component 40 to store each of a plurality of results from the adder 36 and the subtractor 38 and to communicate the stored results to the first memory component 32 for use in a subsequent stage. In the subsequent stage, the controller 52 enables the first memory component 32 to communicate to the adder 36 and to the subtractor 38 a plurality of new pairs of data values consisting first of the add results from the previous stage in the order they were generated and then the subtract results in the order they were generated. Operation of the controller 52 is described in greater detail below.

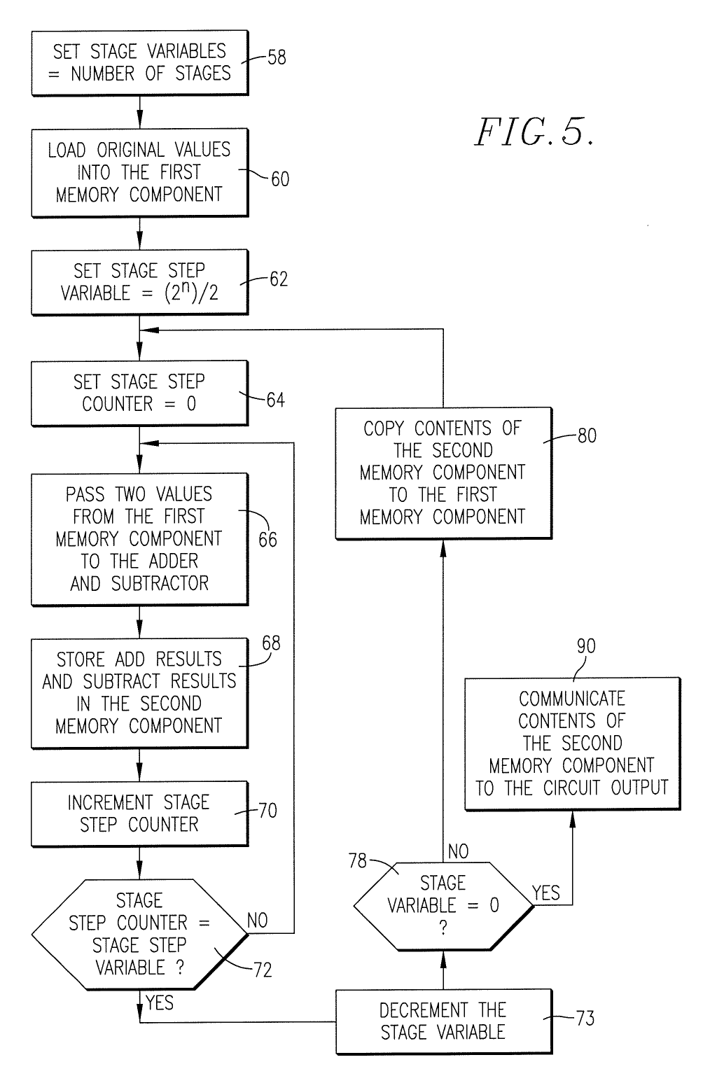

A flow chart of exemplary steps performed by the circuit 26 is illustrated in FIG. 5. The steps illustrated in FIG. 5 do not necessarily need to be performed in the order presented. Moreover, some of the steps may be combined and/or performed simultaneously. The controller 52 receives a number of stages associated with the original data values via the control input 54 and sets a stage variable equal to the number of stages received via the control input 54, as depicted in block 58. The number of stages is equal to log₂(Walsh code length), where the Walsh code length is equal to the number of original data values processed by the circuit 26 at a time. For example, if the Walsh code length is four, the number of stages is two; if the Walsh code length is eight, the number of stages is three; if the Walsh code length is sixteen, the number of stages is four, and so forth. The Walsh code length is limited only by the restrictions and requirements of a particular system in which the circuit 26 is implemented.

Original data values are loaded into the first memory component 32, as depicted in block 60. The original data values are the values upon which the Walsh transformation is to be performed, and may represent all or a portion of a signal. To load the data values, the controller 52 enables the multiplexer to communicate the value stored on the circuit input 30 to the first memory component 32, and enables the first memory component 32 to store the values as they are received. The number N of data values loaded into the first memory component 32 is ₂N and is determined by the controller 52.

The controller 52 then initiates a number of variables. The controller 52 sets a stage step variable equal to 2ⁿ/2, where n is the number of stages, as depicted in block 62; and sets a stage step counter equal to zero, as depicted in block 64. The stage step variable is equal to the total number of steps associated with each stage, and the stage step counter is used by the controller 52 to track the number of steps completed by the circuit 26 during each stage.

The controller 52 then enables the first memory component 32 to communicate two values to the adder 36 and to the subtractor 38, as depicted in block 66. These two values are the first two values stored in the memory component 32. The adder 36 adds the second data value to the first two data and the subtractor 38 subtracts the second data value from the first data value. The add results are presented on the output of the adder 36 and the subtract results are presented on the output of the subtractor 38, wherein the controller 52 enables the second memory component 40 to store both the add results and the subtract results, as depicted in block 68.

The controller 52 increments the stage step counter, as depicted in block 70. The controller 52 then determines whether the stage step counter is equal to the stage step variable, as depicted in block 72. If so, the controller 52 repeats steps 66, 68, and 70 to communicate the next two values stored the first memory component 32 to the adder 36 and subtractor 38 and store the results in the second memory component 40. If the stage step counter is equal to the stage cycle variable, the circuit 26 has completed the first stage of the Walsh transform such that original data values 74 (FIG. 6) stored in the first memory component 32 are converted to the data values 76 stored in the second memory component 40.

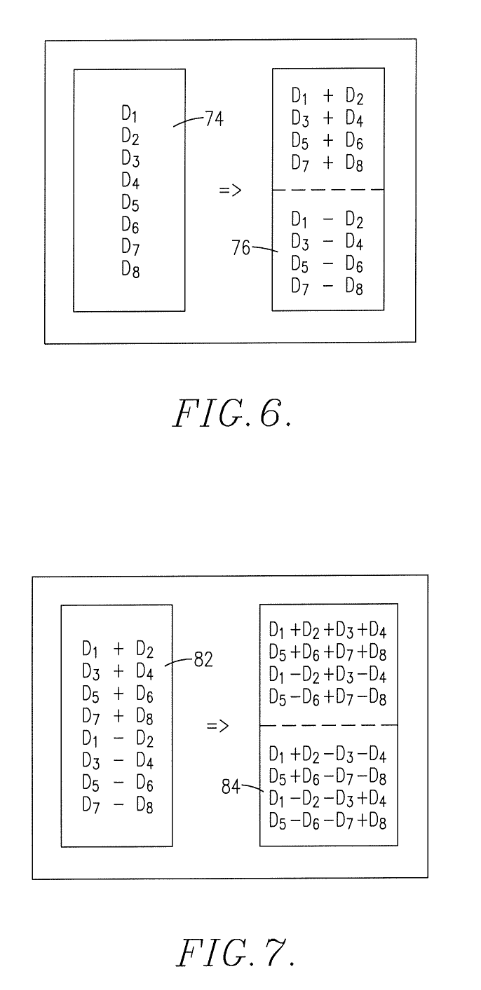

At this point, the controller 52 decrements the stage variable, as depicted in block 73, and determines whether the stage variable is equal to zero, as depicted in block 78. If so, the Walsh transform has been completed and the controller 52 enables the second memory component 40 communicate the most recent set of stored values to the circuit output 50, as depicted in block 90. If the stage variable is not equal to zero, the controller 52 copies contents of the second memory component 40 to the first memory component 32, as depicted in block 80, so that the results 76 of the first stage become the input values 82 (FIG. 7) of the second stage. The controller 52 then decrements the stage variable, as depicted in block 81. The controller 52 then sets the stage cycle counter to zero, as depicted in block 64, and performs loops through steps 66 through 72 until the stage cycle counter is equal to the stage cycle variable.

When the stage cycle counter is equal to the stage cycle variable the second time, the second stage inputs 76 (FIG. 7) are transformed to the second stage results 84. The controller repeats steps 64 through 72 for the third stage, wherein the input values 86 (FIG. 8) stored in the first memory component 32 are converted to the output values 88 stored in the second memory component 40. The third-stage output values 88 are equal to the values of the output matrix 25 of the eight-input Walsh transform of FIG. 3. Thus, with only a single, two-input adder and a singe, two-input subtractor the circuit 26 performed the Walsh transform on the input values D₁ through D₈. The circuit 26 performs the transform regardless of the Walsh code length, provided the memory components 32 and 40 have sufficient capacity to store the data values.

Although the invention has been described with reference to the preferred embodiments illustrated in the attached drawings, it is noted that equivalents may be employed and substitutions made herein without departing from the scope of the invention as recited in the claims.

Having thus described a preferred embodiment of the invention, what is claimed as new and desired to be protected by Letters Patent includes the following:

1. A circuit for processing a set of values, the circuit comprising:
access to a memory component;
an adder;
a subtractor; and
a controller for enabling the memory component, adder, and subtractor to process a set of values in a plurality of stages, wherein in each stage the controller enables the memory to communicate each of a plurality of pairs of values stored in the memory to the adder and to the subtractor to generate add results and subtract results and enables the memory to store the add results and the subtract results for use in a subsequent stage, wherein in the subsequent stage the controller enables the memory to communicate to the adder and to the subtractor a plurality of new pairs of values consisting first of the add results in the order they were generated and then the subtract results in the order they were generated.

2. The circuit as set forth in claim 1, wherein the circuit includes a single adder and a single subtractor.

3. The circuit as set forth in claim 2, wherein the adder includes only two inputs and the subtractor includes only two inputs.

4. The circuit as set forth in claim 1, wherein the pairs of values are consecutive, non-overlapping pairs.

5. The circuit as set forth in claim 1, wherein each pair of values is communicated to the adder and to the subtractor substantially simultaneously.

6. The circuit as set forth in claim 1, wherein the circuit is an integrated circuit.

7. The circuit as set forth in claim 1, wherein each value of the set of values is a sixteen-bit integer, the adder includes two sixteen-bit inputs and a sixteen-bit output, and the subtractor includes two sixteen-bit inputs and a sixteen-bit output.

8. The circuit as set forth in claim 1, wherein the set of values consists of a number of values equal to 2, where n is an integer greater than one.

9. The circuit as set forth in claim 8, wherein the controller receives an input indicating a number of stages, and wherein the controller executes the number of stages indicated by the input.

10. The circuit as set forth in claim 9, wherein the number of stages is equal to n.

11. The circuit as set forth in claim 1, wherein the controller enables the memory to communicate to the adder and to the subtractor the plurality of new pairs of values according to a pattern wherein a second add result is subtracted from a first add result, a fourth add result is subtracted from a third add result, a second subtract result is subtracted from a first subtract result, a fourth subtract result is subtracted from a third subtract result.

12. A method of performing a Walsh transform on a set of values, the method comprising:
communicating each of a plurality of pairs of values stored in a memory circuit to an adder input and to a subtractor input;
storing in the memory circuit an output value of the adder and an output value of the subtractor corresponding to each pair of values; and
communicating to the adder input and to the subtractor input the adder output values and the subtractor output values stored in the memory circuit, wherein the adder output values and the subtractor output values are communicated to the adder input and to the subtractor input in pairs consisting first of the adder output values in the order they were generated and then the subtractor output values in the order they were generated.

13. The method as set forth in claim 12, wherein the plurality of pairs of values stored in the memory circuit are non-overlapping, consecutive pairs.

14. The method as set forth in claim 12, wherein the total number of values that make up the plurality of pairs of values stored in the memory circuit is a power of two.

15. The method as set forth in claim 12, further comprising communicating to the adder and to the subtractor the adder outputs and the subtractor outputs stored in the memory circuit according to a pattern wherein a second adder output is subtracted from a first adder output, a fourth adder output is subtracted from a third adder output, a second subtractor output is subtracted from a first subtractor output, a fourth subtractor output is subtracted from a third subtractor output.

16. A circuit for performing a discrete Walsh transform on a set of signal values, the circuit comprising:
a first memory component with an input and an output;
a second memory component with an input and an output;
a single, two-input adder with first and second inputs connected to the output of the first memory component and an output connected to the input of the second memory component, wherein the first input receives a first value from the first memory component and the second input receives a second value from the first memory component;
a single, two-input subtractor with first and second inputs connected to the output of the first memory component and an output connected to the input of the second memory component, wherein the first input receives a first value from the first memory component and the second input receives a second value from the first memory component;
input circuit elements for receiving a stage value;
arithmetic control circuit elements for enabling the first memory component to communicate pairs of data values to the adder and the subtractor, and enabling the second memory component to store an output of the adder and an output of the subtractor corresponding to each pair of input values, wherein the add results are stored sequentially first, in the order they were generated, and the subtract results are stored sequentially after the add results, in the order they were generated; and
stage control circuit elements for enabling the second memory component to communicate the outputs of the adder and the subtractor to the first memory component when the number of pairs communicated to the adder and the substractor equals one-half of the stage value, wherein the outputs of the adder are stored in the first memory component in the same order they were stored in the second memory component.

17. The circuit as set forth in claim 16, wherein the arithmetic control circuit elements enable the second memory component to store the outputs of the adder and the outputs of the subtractor according to a pattern wherein, in a subsequent stage, a second add result is subtracted from a first add result, a fourth add result is subtracted from a third add result, a second subtract result is subtracted from a first subtract result, a fourth subtract result is subtracted from a third subtract result.
